(19) United States
(12) Patent Application Publication
(10) Pub. No.: US 2024/0182648 A1
(43) Pub. Date: Jun. 6, 2024

(54) OXYALKYLATED LIGNIN POLYOLS, RELATED COMPOSITIONS, AND RELATED METHODS

(71) Applicant: BOARD OF TRUSTEES OF MICHIGAN STATE UNIVERSITY, East Lansing, MI (US)

(72) Inventors: Mojgan Nejad, Okemos, MI (US); Saeid Nikafshar, East Lansing, MI (US)

(21) Appl. No.: 18/281,639

(22) PCT Filed: Mar. 11, 2022
(86) PCT No.: PCT/US22/19867

§ 371 Date: Sep. 12, 2023

Related U.S. Application Data
(60) Provisional application No. 63/160,534, filed on Mar. 12, 2021.

(51) Int. Cl. C08H 7/00; C08G 18/64; C08G 63/12

(52) U.S. Cl. CPC C08H 6/00; C08G 18/6492; C08G 63/12

(57) ABSTRACT

The disclosure relates to methods for forming oxyalkylated lignin polyols as well as related polyols and polymers. In the various methods, an initial reaction mixture including a cyclic alkyl carbonate and a wet lignin is heated in the absence of an oxyalkylation catalyst to remove at least a portion of the water from the reaction mixture. An oxyalkylation catalyst is added to the resulting dehydrated reaction mixture, which is then heated to perform an oxyalkylation reaction between the cyclic alkyl carbonate with the lignin, thereby forming an oxyalkylated lignin polyol reaction product. The oxyalkylated lignin polyol can be subsequently reacted with a polyisocyanate or a polyacid compound to form a corresponding polyurethane or polyester polymer, respectively. The disclosure further relates to the oxyalkylated lignin polyols and corresponding polymers formed therefrom.

### CROSS REFERENCE TO RELATED APPLICATION

Priority is claimed to U.S. Provisional Application No. 63/160,534 filed on Mar. 12, 2021, which is incorporated herein by reference in its entirety.

### STATEMENT OF GOVERNMENT INTEREST

None.

### BACKGROUND OF THE DISCLOSURE

### Field of the Disclosure

The disclosure relates to methods for forming oxyalkylated lignin polyols as well as related polyols and polymers. An initial reaction mixture including a cyclic alkyl carbonate and a wet lignin is heated in the absence of an oxyalkylation catalyst to remove at least a portion of the water from the reaction mixture. An oxyalkylation catalyst is added to the resulting dehydrated reaction mixture, which is then heated to perform an oxyalkylation reaction between the cyclic alkyl carbonate with the lignin, thereby forming an oxyalkylated lignin polyol reaction product. The oxyalkylated lignin polyol can be subsequently reacted with a polyisocyanate or a polyacid compound to form a corresponding polyurethane or polyester polymer.

### SUMMARY

In one aspect, the disclosure relates to a method for forming an oxyalkylated lignin polyol, the method comprising: providing a reaction mixture comprising: a cyclic alkyl carbonate (e.g., in liquid form as reaction medium), and a lignin comprising water in an amount of at least 1 wt. % (or at least 5 wt. %) relative to the lignin, wherein the reaction mixture is substantially free from an oxyalkylation catalyst; heating the reaction mixture for a time sufficient to remove at least a portion of the water from the reaction mixture (e.g., without substantial removal of the cyclic alkyl carbonate), thereby forming a dehydrated reaction mixture (i) comprising the cyclic alkyl carbonate and the lignin, (ii) having a water content of 0.5 wt. % or less (or 1 wt. % or less) relative to the lignin, and (iii) being substantially free from an oxyalkylation catalyst; adding an oxyalkylation catalyst to the dehydrated reaction mixture and performing an oxyalkylation reaction therein to react the cyclic alkyl carbonate with the lignin, for example via aromatic/phenolic and/or aliphatic hydroxy groups and/or carboxylic acid groups thereof, thereby forming an oxyalkylated lignin polyol reaction product. The water content of the initial (wet) lignin and after water removal is generally expressed on a dry weight basis relative to the lignin, for example relative to the solid lignin content without water.

Various refinements of the disclosed method and corresponding oxyalkylated lignin polyol are possible.

In a refinement, the cyclic alkyl carbonate has an alkyl group containing from 2 to 20 carbon atoms. For example, the cyclic alkyl carbonate can have at least 2, 3, 4, 5, or 6 and/or up to 3, 4, 5, 6, 8, 10, 12, 15, or 20 carbon atoms. The alkyl group can be linear or branched and/or substituted or unsubstituted. The alkyl group and the corresponding cyclic alkyl carbonate preferably does not include any free hydroxyl groups, free amine groups, and/or free carboxylic acid/carboxylate groups (e.g., when the alkyl group is a substituted group). The alkyl group does not include the carbon atom in the carbonyl group of the carbonate. Thus, the cyclic alkyl carbonate has 3 to 21 total carbon atoms in this embodiment. The alkyl group can be linked to the carbonate group oxygen atoms at adjacent carbon atoms (e.g., as in propylene carbonate with a 3-carbon alkyl group or ethylene carbonate with a 2-carbon alkyl group) or at non-adjacent carbon atoms (e.g., as in trimethylene carbonate with a 3-carbon alkyl group).

More generally, the cyclic alkyl carbonate is not particularly limited and can include any cyclic structure including a carbonate group (—OC(═O)O—) linked to an alkyl hydrocarbon group at both carbonate oxygen atoms, thus forming a cyclic structure from five or more atoms (e.g., one carbonyl carbon atom, two carbonate oxygen atoms, and at least two alkyl carbon atoms). The cyclic alkyl carbonate suitably is in liquid form both at lower ambient temperatures (e.g., room temperature or about 20-30° C.) and/or at higher temperatures that may be useful reaction temperatures for prepolymerization and/or curing. For example, propylene carbonate has a melting point of −49° C. and a boiling point of 242° C. Similarly, ethylene carbonate has a melting point of 35° C. and a boiling point of 243° C., so it would be useful, for example, in a high-temperature formulation (i.e., where it is in liquid form) or in liquid solution with another cyclic alkyl carbonate that is liquid at lower ambient temperatures, such as propylene carbonate. The cyclic alkyl carbonate further suitably serves as a solvent for the lignin, thus assisting water removal via solubilization of the lignin and release of the lignin's water into the liquid cyclic alkyl carbonate (e.g., as a dispersed aqueous phase) for subsequent removal via heating or distillation. Different lignins have varying solubilities in the cyclic alkyl carbonate medium. For example, organosolv lignins are soluble in propylene carbonate at room temperature, while other lignins such as kraft are soluble in propylene carbonate at higher temperatures of about 100-120° C. In either case, the lignin is solubilized at temperatures suitable for water removal via heating.

In a refinement, the cyclic alkyl carbonate has a structure according to Formula I, wherein: n is 1 to 10; i is each of 1 to n; and Rᵢ, R′ᵢ, Rₙ₊₁, and R′ₙ₊₁ are independently selected from the group consisting of H and linear or branched, substituted or unsubstituted C₁-C₁₀ alkyl groups. In the illustrated Formula I, the index n takes a single value from 1 to 10, such as 1, 2, or 3, for example at least 1, 2, or 3 and/or up to 2, 4, 6, 8, or 10. The index i takes all of the values from 1 to n for a given value of n (i.e., there are “i” groups for each of the n+1 total carbons in the ring). Rᵢ, R′ᵢ, Rₙ₊₁, and R′ₙ₊₁ can independently be H or linear or branched, substituted or unsubstituted C₁-C₁₀ alkyl groups, such as alkyl groups with 1, 2, or 3 carbons, for example at least 1, 2, or 3 and/or up to 2, 4, 6, 8, or 10 carbons. Substituents for substituted alkyl groups are generally not limited, but preferably do not include isocyanate-reactive groups such as hydroxyl groups, amine groups (e.g., primary, secondary), and carboxylic acid/carboxylate groups. For example, if n=2, then the structure of Formula I will have R₁, R′₁, R₂, R′₂, R₃, and R′₃ substituents, which can be independently selected to be hydrogen atoms or the alkyl groups noted above. Examples of suitable cyclic alkyl carbonates include propylene carbonate, ethylene carbonate, trimethylene carbonate, butylene carbonates (e.g., derived from one or more butanediols such as 1,2-, 1,3-, 1,4-, or 2,3-butanediol), pentylene carbonates (e.g., derived from one or more pentanediols), etc. In the context of the structure of Formula I for propylene carbonate, n is 1; R₁, R′₁, and R′₂ are H; and R₂ is CH₃. For ethylene carbonate, n is 1; and R₁, R′₁, R₂, and R′₂ are H. For trimethylene carbonate, n is 2; and R₁, R′₁, R₂, R′₂, R₃, and R′₃ are H.

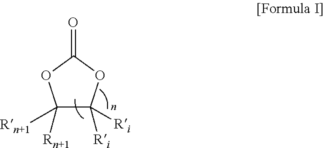

In a refinement, the (unmodified) lignin is derived from a biomass selected from the group consisting of hardwoods, softwoods, grasses, and combinations thereof.

In a refinement, the (unmodified) lignin is isolated from an extraction process selected from the group consisting of Kraft extraction, soda extraction, organosolv extraction, enzymatic hydrolysis extraction, ionic liquid, extraction, sulfite extraction, and combinations thereof.

The lignin is not particularly limited and generally can include lignin from any lignocellulosic biomass. Plants, in general, are comprised of cellulose, hemicellulose, lignin, extractives, and ash. Lignin typically constitutes 15-35 wt. % of woody plant cell walls, is an amorphous aromatic polymer made of phenylpropane units (e.g., coniferyl alcohol, sinapyl alcohol, p-coumaryl alcohol). The lignin for use according to the disclosure is not particularly limited to the source of lignin or its isolation method. Any type of lignin regardless of the biomass type (hardwood, softwood, grasses, and other agricultural residues) isolated through any extraction methods (such as Kraft, soda, organosolv, sulfite, enzymatic hydrolysis, and Ionic liquid) is suitable for use in the disclosed compositions and articles.

The lignin incorporated into the reaction mixture for oxyalkylation is generally an unmodified lignin. Unmodified lignin as used herein refers to lignin that has been separated from other components of its lignocellulosic biomass feedstock, such as the cellulose, hemicellulose, and other plant material components. Such separation processes (e.g., Kraft, soda, organosolv, sulfite, enzymatic hydrolysis, and ionic liquid) to isolate lignin from biomass may hydrolyze or otherwise fragment larger lignin molecules into smaller fragments, but this fragmentation and molecular weight reduction is still considered to provide an unmodified lignin as used herein in the corresponding compositions and methods. Such isolated lignins, which are also known as technical lignins, have not been subjected to further modifications or fragmentations, and are considered to provide an unmodified lignin as used herein in the corresponding compositions and methods. Modifications (or chemical modifications) that are generally avoided for the lignin used herein can include one or more of demethylation, phenolation, hydroxymethylation, etherification, depolymerization, and fractionation to monomer, dimers, trimers and oligomers.

The unmodified lignin is generally polymeric, as contrasted with various lignin monomers such as one or more of coniferyl alcohol, sinapyl alcohol, and p-coumaryl alcohol. For example, the unmodified lignin can have an average molecular weight (e.g., weight-average molecular weight, Mw) of at least 500 g/mol or at least 1000 g/mol. While technical lignins or other commercial lignins isolated from biomass could have some lignin monomers in the distribution of lignin components, the fraction of such lignin monomers in the unmodified lignin is suitably small, for example as reflected by the minimum average molecular weight of the unmodified lignin. In some embodiments, the unmodified lignin contains less than 10, 5, 2, 1, 0.5, 0.2, or 0.1 wt. % lignin monomers relative to the total unmodified lignin.

In a refinement, the (unmodified) lignin, prior to incorporation into the reaction mixture, has at least one of the following properties: a molecular weight in a range of 500 to 20000; a polydispersity in a range of 1.2 to 8; an aliphatic hydroxyl content in a range of 1 to 4 mmol/g; a phenol hydroxyl content in a range of 2 to 5 mmol/g; a carboxylic hydroxyl content less than 1 mmol/g; and a total hydroxyl content in a range of 3 to 9 mmol/g.

In a refinement, the (unmodified) lignin, prior to incorporation into the reaction mixture, has the following properties: a number-average molecular weight (Mn) in a range of 500 to 5000 (or 1000 to 3000); a polydispersity in a range of 1.2 to 8 (or 2 to 4); a phenol hydroxyl content in a range of 1 to 7 mmol/g (or 2 to 5 mmol/g); a relative phenol hydroxyl content of at least 45% (or at least 55%) relative to hydroxyl groups of the unmodified lignin; and a carboxylic hydroxyl content less than 1 mmol/g (or less than 0.5 mmol/g).

More generally, the (unmodified) lignin, prior to reaction and/or incorporation into a reaction mixture for removal of water, suitably can be selected to have one or more properties related to molecular weight, molecular weight distribution, hydroxyl content, and hydroxyl content distribution. For example, a lower molecular weight and/or a lower polydispersity index can be desirable to promote access to and reactivity of the phenolic (or aromatic) hydroxy groups of the lignin, but lignin with any molecular weight and/or polydispersity can be used. Suitably, the weight-average molecular weight (M_{w}) can be in a range of 500 to 50000, 1000 to 3000, 3000 to 7000, 3000 to 10000, or 10000 to 50000. For example, M_{w} independently can be at least 500, 800, 1000, 1500, 2000, or 3000 and/or up to 1000, 1200, 1500, 2000, 3000, 5000, 7000, 10000, 15000, or 50000, but higher values are possible. Similar ranges can apply to the number-average molecular weight (Mₙ). Alternatively or additionally, the polydispersity index (M_{w}/Mₙ) can be in a range of 1.2 to 10, 1.2 to 8, 1.2 to 5, or 2 to 4, for example being at least 1.2, 1.4, 1.6, 1.8, or 2 and/or up to 1.5, 1.8, 2.0, 3.0, 4.0, 5.0, 6.0, 8.0, or 10, but higher values are possible. In a refinement, the aliphatic hydroxyl content of the unmodified lignin can be in a range of 0.5 to 7 mmol/g, 1 to 4 mmol/g, or 1 to 3 mmol/g, for example being at least 0.5, 1, 1.5 or 2 and/or up to 2, 2.5, 3, 3.5, 4, 5, 6, or 7 mmol/g. In a refinement, the phenol hydroxyl content of the unmodified lignin can be in a range of 1 to 7 mmol/g, 2 to 6 mmol/g, or 3 to 6 mmol/g, for example being at least 1, 1.5, 2, 2.5, 3, or 3.5 and/or up to 3, 3.5, 4, 4.5, 5, 5.5, 6, or 7 mmol/g. Alternatively or additionally, the phenol hydroxyl content can be at least 40, 50, 60, or 70% and/or up to 60, 65, 70, 75, or 80% of the total hydroxyl groups of the unmodified lignin (e.g., aliphatic, phenolic/aromatic, and carboxylic hydroxyl groups combined). Similarly, the phenol hydroxyl content individually can be greater than the aliphatic hydroxyl content individually and the carboxylic hydroxyl content individually. In a refinement, the carboxylic hydroxyl content of the unmodified lignin can be less than 1 mmol/g or 2 mmol/g, for example being at least 0.01, 0.1, or 0.2 and/or up to 0.2, 0.3, 0.4, 0.5, 0.7, 1, 1.5, or 2 mmol/g. In a refinement, the total hydroxyl content of the unmodified lignin can be in a range of 2 to 10 mmol/g, 3 to 9 mmol/g, or 4 to 7 mmol/g, for example being at least 2, 2.5, 3, 3.5, 4, 4.5, or 5 and/or up to 3.5, 4, 4.5, 5, 6, 7, 8, 9, or 10 mmol/g.

In a refinement, the cyclic alkyl carbonate is present in the reaction mixture in an amount in a range of 2 eq to 10 eq relative to the lignin hydroxyl content. For example, the cyclic alkyl carbonate can be present in the reaction mixture in an amount of at least 2, 2.5, 3, 3.5, 4, or 5 eq and/or up to 3, 4, 5, 6, 7, 8, or 10 eq relative to the lignin hydroxyl content. The molar equivalent “eq” unit represents in this case moles of cyclic alkyl carbonate molecules or moles of total hydroxyl (—OH) groups initially in the lignin, which represents the sum of phenolic/aromatic hydroxyl, aliphatic hydroxyl groups, and carboxylic acid hydroxyl groups initially in the lignin. Alternatively or additionally, the content of the reaction mixture can be expressed on a weight basis, for example containing 50-95 wt. % (e.g., at least 50, 60, or 70 wt. % and/or up to 70, 80, 90, or 95 wt. %) cyclic alkyl carbonate and 5-50 wt. % lignin (e.g., at least 5, 10, 15, 20, or 25 wt. % and/or up to 20, 30, 40, or 50 wt. %) (dry weight basis) based on the combined amount of cyclic alkyl carbonate and lignin (dry weight basis). There is generally no need to add solvents or other components to the reaction mixture, such that the (initial) reaction mixture is typically at least 95, 98, 99, or 99.5 wt. % of cyclic alkyl carbonate, lignin, and water combined, based on the combined weight of the reaction mixture.

In a refinement, the reaction mixture contains less than 0.01 wt. % of an oxyalkylation catalyst based on the reaction mixture. More generally, the initial reaction mixture prior to heating to remove water is suitably free or substantially free of any oxyalkylation catalyst, for example not having any added oxyalkylation catalyst (e.g., no initial added amount of the oxyalkylation catalyst that is added after water removal). In embodiments, the reaction mixture contains less than 0.01, 0.001, 0.0001, or 0.00001 wt. % of any oxyalkylation catalysts, based on the combined weight of the reaction mixture.

In a refinement, the lignin initially in the reaction mixture comprises water in an amount in a range of 5 wt. % to 70 wt. % (10 wt. % to 50 wt. %) relative to the lignin (dry weight basis); and the dehydrated reaction mixture has a water content of 0.2 wt. % or less (or 0.1 wt. % or less) relative to the lignin. More generally, the wet lignin initially in or added to the reaction mixture can have a water content of at least 1, 2, 5, 10, 15, 20, 25, 30, 40, or 50 wt. % and/or up to 20, 30, 40, 50, 60, 70, 80, or 100 wt. % relative to the lignin (dry weight basis). Alternatively or additionally, the dehydrated reaction mixture can have a water content of at least 0.001, 0.01, or 0.1 wt. % and/or up to 0.1, 0.2, 0.3, 0.4, 0.5, 0.6, 0.8, or 1 wt. % relative to the lignin (dry weight basis). Alternatively or additionally, the dehydrated reaction mixture can have a water content of at least 0.0001, 0.001, 0.01, or 0.03 wt. % and/or up to 0.03, 0.05, 0.07, 0.1, 0.15, 0.2, 0.3, or 0.4 wt. % relative to the dehydrated reaction mixture as a whole.

In a refinement, the method comprises heating the reaction mixture to remove the water at a temperature in a range of 100° C. to 230° C. The heating more generally is performed at an elevated temperature sufficient to vaporize and remove water from the reaction mixture, but at a temperature low enough to avoid substantial vaporization and removal of the cyclic alkyl carbonate from the reaction mixture. Accordingly, suitable heating temperatures for water removal can be in the range of 100° C. to 230° C., for example at least 100, 120, 130, 150, 170, or 200° C., and/or up to 150, 160, 180, 200, 220, or 230° C., and/or up to a temperature that is 5-20° C., 20-40° C., or 40-60° C. below the boiling point of the cyclic alkyl carbonate. Suitable heating times (or residence times in a continuous system) can be in the range of 0.25-24 hr, 0.5-12 hr, or 1-6 hr.

In a refinement, the method comprises adding the oxyalkylation catalyst to the dehydrated reaction mixture in an amount in a range of 0.01 eq to 0.2 eq relative to the lignin hydroxyl content. For example, the oxyalkylation catalyst can be present in the reaction mixture in an amount of at least 0.01, 0.02, 0.03, 0.04, or 0.05 eq and/or up to 0.06, 0.08, 0.1, 0.15, or 0.2 eq relative to the lignin hydroxyl content. The molar equivalent “eq” unit represents in this case moles of oxyalkylation catalyst molecules or moles of total hydroxyl (—OH) groups initially in the lignin, which represents the sum of phenolic/aromatic hydroxyl, aliphatic hydroxyl groups, and carboxylic acid hydroxyl groups initially in the lignin.

The oxyalkylation catalysts useful according to the disclosure are not particularly limited and can generally include base catalysts (e.g., strong bases or super bases), for example those known for use in transesterification reactions. Examples include 1,8-diazabicyclo[5.4.0]undec-7-ene (DBU), 1,5,7-Triazabicyclo[4.4.0]dec-5-ene, 1,4-diazabicyclo[2.2.2]octane (DABCO), potassium tert-butoxide, tetra-n-butylammonium bromide (TBAB) (phase transfer catalyst), potassium carbonate, pyridine, and triethylene amine.

In a refinement, the oxyalkylated lignin polyol reaction product has an aliphatic hydroxy content in a range of 0.2 mmol/g to 6 mmol/g. For example, the oxyalkylated lignin polyol can have an aliphatic hydroxy content of at least 0.2, 0.3, 0.5, 0.6, 0.8, 1, 1.2, 1.5, 1.7, 2, 2.5, 3, 3.5, or 4 mmol/g and/or up to 0.7, 1, 1.2, 1.5, 1.8, 2, 2.5, 3, 3.5, 4, 4.5, 5, 5.5, or 6 mmol/g.

The disclosed method can provide an oxyalkylated lignin polyol reaction product having an aliphatic hydroxy content that can be selected within a relatively wide range depending on a desired end use for the oxyalkylated lignin polyol. For example, oxyalkylated lignin polyols having relatively high aliphatic hydroxy contents (e.g., about 3 to 6 mmol/g) are particularly suitable for forming rigid polyurethane foams, because the high aliphatic hydroxy content provides many isocyanate-reactive sites that can in turn provide a high crosslinking density in a corresponding polyurethane polymer. Similarly, oxyalkylated lignin polyols having relatively low aliphatic hydroxy contents (e.g., about 0.5 to 2 mmol/g) are particularly suitable for forming flexible polyurethane foams or elastomers, because the low aliphatic hydroxy content provides sufficient isocyanate-reactive sites for polymerization, but not so many that would result in a highly crosslinked polyurethane polymer.

The oxyalkylation reaction can convert essentially all aromatic hydroxy and carboxylic acid groups in the original lignin to aliphatic hydroxy groups. For example, the oxyalkylated lignin polyol reaction product can be free or substantially free of aromatic hydroxy groups and/or carboxylic acid groups, such as having 0.001, 0.01, or 0.1 mmol/g or less aromatic hydroxy groups and/or carboxylic acid groups. Typically at least some of the original aliphatic hydroxy groups in the lignin also react via the oxyalkylation reaction such that the aliphatic hydroxy content in the oxyalkylated lignin polyol reaction product includes at least the oxyalkylated aliphatic hydroxy groups, but possibly also some remaining unreacted original aliphatic hydroxy groups in the lignin. The total number of hydroxy groups (e.g., aromatic, carboxylic, and aliphatic hydroxy groups combined) in a given molecule is generally conserved during the oxyalkylation reaction, but the overall molecular weight is generally increased with the addition of oxyalkyl groups, thus resulting in a lower total hydroxy group content on a per mass basis between the original lignin and the final oxyalkylated lignin polyol.

In a refinement, the method comprises performing the oxyalkylation reaction at a temperature in a range of 100° C. to 200° C. The oxyalkylation reaction more generally is performed at an elevated temperature (e.g., above 100° C.) to improve the rate and yield of the transesterification reaction, thereby improving the conversion of aromatic hydroxyl groups and to aliphatic hydroxyl groups in the oxyalkylated lignin polyol reaction product. Suitable reaction temperatures for the oxyalkylation reaction can be in the range of at least 100, 110, 120, 130, or 140° C. and/or up to 120, 140, 150, 160, 170, 180, or 200° C. Suitable reaction times (or residence times in a continuous system) can be in the range of 0.25-24 hr, 0.5-12 hr, or 1-6 hr, for example about 3 hr.

In a refinement, the method comprises performing the oxyalkylation reaction in a sealed reaction vessel. The oxyalkylation reaction is suitably performed in a closed or sealed reaction or pressure vessel, typically at a pressure above ambient or environmental pressure to prevent any inflow of air from the external environment. Performing the reaction in a sealed reaction vessel limits or prevents the loss of cyclic alkyl carbonate reactant during the reaction, thus improving conversion and yield for a given amount of added cyclic alkyl carbonate. Although the reaction temperature is generally below the boiling point of the cyclic alkyl carbonate (e.g., about 242° C. for propylene carbonate), the reaction temperature and corresponding vapor pressure of the cyclic alkyl carbonate is high enough to result in some vaporization and loss of the reactant in a reaction vessel open to the environment. Suitable reaction pressures can be in a range of 0.03-1 bar (about 0.5-15 psi), for example at least 0.03, 0.06, 0.1, 0.2, or 0.3 bar and/or up to 0.3, 0.5, 0.7, or 1 bar above ambient or environmental pressure (or a gauge pressure). The internal gaseous headspace in the reactor above the liquid reaction medium is suitably any inert or non-oxygen-containing gas such as nitrogen gas.

In a further refinement, the method further comprises venting carbon dioxide produced during the oxyalkylation reaction from the sealed reaction vessel. Carbon dioxide is a byproduct of the oxyalkylation reaction as shown in Schemes 1 and 2. Accumulation of carbon dioxide in the reaction system is undesirable, because it can create excessive pressures in the reaction vessel as well as increased concentrations of carbon dioxide in the liquid reaction medium. Carbon dioxide in the liquid reaction medium can neutralize and deactivate base catalyst compounds such as DBU serving as the oxyalkylation catalyst, thus limiting overall conversion. Thus in some embodiments, it can be desirable to periodically vent accumulated carbon dioxide in the reaction vessel headspace to reduce the overall carbon dioxide in the reaction system. After venting, the reaction system is returned to a closed or sealed state while the reaction continues, thus limiting possible loss of the cyclic alkyl carbonate during the reaction.

In a refinement, the method further comprises adding additional cyclic alkyl carbonate and additional oxyalkylation catalyst to the dehydrated reaction mixture while performing the oxyalkylation reaction. As described above, the oxyalkylation catalyst can become ineffective during the course of an oxyalkylation reaction due to accumulation of carbon dioxide and catalyst deactivation, even with venting to remove carbon dioxide. In such cases, additional amounts of cyclic alkyl carbonate and fresh oxyalkylation catalyst can be added to the reaction vessel after starting the reaction with the initial cyclic alkyl carbonate and oxyalkylation catalyst. For example, evolution of carbon dioxide during the reaction can be monitored as an indicator of rate of reaction; when the rate of reaction drops significantly or stops, the additional cyclic alkyl carbonate and fresh oxyalkylation catalyst can be added to resume the reaction. Addition of the cyclic alkyl carbonate in separate aliquots in this manner also maintains a relatively lower excess of the carbonate, which in turn promotes reaction with the lignin instead of carbonate-carbonate self-polymerization.

In a refinement, the method further comprises adding an isocyanate (e.g., diisocyanate) to the oxyalkylated lignin polyol reaction product and reacting the isocyanate and the oxyalkylated lignin polyol reaction product to form a polyurethane polymer. An advantage of the disclosed process is that oxyalkylated lignin polyol as originally formed is suitable for further reaction to form a corresponding polyurethane directly in the same reaction vessel used for both water removal and oxyalkylation (e.g., as a one-pot synthesis starting from wet lignin). The polyurethane can be a highly crosslinked thermoset, a lightly or non-crosslinked polymer, elastomer, etc. depending on the hydroxy content of the oxyalkylated lignin polyol and the functionality of the isocyanate. Typically, the base catalysts that are suitable as oxyalkylation catalysts also catalyze the reaction between the oxyalkylated lignin polyol and the isocyanates, so any residual catalyst remaining after oxyalkylation is generally sufficient for polyurethane formation. In some cases, due to the generally higher rate of reaction for the polyurethane formation, it can be desirable to neutralize some of the residual catalyst remaining after oxyalkylation (i.e., lowering the amount of active catalyst but retaining at least some active catalyst).

The isocyanate is not particularly limited and generally can include any aromatic, alicyclic, and/or aliphatic monomeric, oligomeric, and/or polymeric isocyanates having at least two reactive isocyanate groups (—NCO) (e.g., di- or higher poly-functional isocyanates). Suitable isocyanates contain on average 2-4 isocyanate groups. In some embodiments, the isocyanate includes a diisocyanate. In some embodiments, the isocyanate includes triisocyanate. Suitable diisocyanates can have the general structure (O═C═N)—R—(N═C═O), where R can include aromatic, alicyclic, and/or aliphatic groups, for example having at least 2, 4, 6, 8, 10 or 12 and/or up to 8, 12, 16, or 20 carbon atoms. Examples of specific isocyanates include 1,5-naphthylene diisocyanate, 4,4′-diphenylmethane diisocyanate (MDI), hydrogenated MDI, polymeric methylene diphenyl diisocyanate (pMDI), xylene diisocyanate (XDI), tetramethylxylol diisocyanate (TMXDI), 4,4′-diphenyl-dimethylmethane diisocyanate, di- and tetraalkyl-diphenylmethane diisocyanate, 4,4′-dibenzyl diiso-cyanate, 1,3-phenylene diisocyanate, 1,4-phenylene diisocyanate, one or more isomers of tolylene diisocyanate (TDI, such as toluene 2,4-diisocyanate), 1-methyl-2,4-diiso-cyanatocyclohexane, 1,6-diisocyanato-2,2,4-trimethyl-hexane, 1,6-diisocyanato-2,4,4-trimethylhexane, 1-iso-cyanatomethyl-3-isocyanato-1,5,5-trimethylcyclohexane, chlorinated and brominated diisocyanates, phosphorus-containing diisocyanates, 4,4′-diisocyanatophenyl-perfluoroethane, tetramethoxybutane 1,4-diisocyanate, butane 1,4-diisocyanate, hexane 1,6-diisocyanate (or hexamethylene diisocyanate; HDI), HDI dimer (HDID), HDI trimer (HDIT), HDI biuret, dicyclohexylmethane diisocyanate, cyclohexane 1,4-diisocyanate, ethylene diisocyanate, phthalic acid bisisocyanatoethyl ester, 1-chloromethylphenyl 2,4-diisocyanate, 1-bromomethylphenyl 2,6-diisocyanate, 3,3-bischloromethyl ether 4,4′-diphenyldiisocyanate, trimethylhexamethylene diisocyanate, 1,4-diisocyanato-butane, 1,2-diisocyanatododecane, and combinations thereof. The isocyanate can be biobased or made of synthetic feedstock. Examples of suitable biobased isocyanates include pentamethylene diisocyanate trimer, and isocyanates formed from base compounds to which isocyanate groups are attached (e.g., via suitable derivatization techniques), including isocyanate-terminated poly(lactic acid) having two or more isocyanate groups, isocyanate-terminated poly(hydroxyalkanaotes) having two or more isocyanate groups, isocyanate-terminated biobased polyesters having two or more isocyanate groups.

In a refinement, the method further comprises adding an organic acid (e.g., diacid) to the oxyalkylated lignin polyol reaction product and reacting the organic acid and the oxyalkylated lignin polyol reaction product to form a polyester polymer. This is analogous to the polyurethane formation as described above, but using an organic di- or higher-functional acid to form a corresponding polyester. Examples of suitable organic acids include alkyl and/or aryl acids such as terephthalic acid, maleic acid, and fumaric acid.

In another aspect, the disclosure relates to an oxyalkylated lignin polyol reaction product formed according to the disclosed method in any of its variously disclosed embodiments, refinements, etc. For example, in some aspects, the disclosure relates to an oxyalkylated lignin polyol comprising a reaction product between a cyclic alkyl carbonate and a lignin, the reaction product having one or more properties such as an aliphatic hydroxy content in a range of 0.2 mmol/g to 6 mmol/g, 0.1 mmol/g or less aromatic hydroxy groups, and/or 0.1 mmol/g or less carboxylic acid groups (or any disclosed sub-range(s) thereof).

In another aspect, the disclosure relates to a polyurethane polymer comprising: a (crosslinked) reaction product between an oxyalkylated lignin polyol (e.g., in any of its variously disclosed embodiments, refinements, etc.) and an isocyanate, for example as a product formed according to any of the variously disclosed methods.

In another aspect, the disclosure relates to a polyester polymer comprising: a (crosslinked) reaction product between the oxyalkylated lignin polyol (e.g., in any of its variously disclosed embodiments, refinements, etc.) and an organic acid, for example as a product formed according to any of the variously disclosed methods.

While the disclosed methods, compositions, and articles are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### DETAILED DESCRIPTION

The disclosure relates to methods for forming oxyalkylated lignin polyols as well as related polyols and polymers. In the various methods, an initial reaction mixture including a cyclic alkyl carbonate and a wet lignin (e.g., having at least 1, 2, or 5 wt. % water on a lignin dry weight basis) is heated in the absence of an oxyalkylation catalyst to remove at least a portion of the water from the reaction mixture. An oxyalkylation catalyst is added to the resulting dehydrated reaction mixture (e.g., having 1, 0.5, 0.2, or 0.1 wt. % water or less on a lignin dry weight basis), which is then heated to perform an oxyalkylation reaction between the cyclic alkyl carbonate with the lignin, for example via aromatic/phenolic and/or aliphatic hydroxy groups and/or carboxylic acid groups of the lignin, thereby forming an oxyalkylated lignin polyol reaction product. The oxyalkylated lignin polyol can be subsequently reacted with a polyisocyanate or a polyacid compound to form a corresponding polyurethane or polyester polymer, respectively. The disclosure further relates to the oxyalkylated lignin polyols and corresponding polymers formed therefrom.

The various methods known in the art for isolating or extracting lignin from biomass generally result in a lignin material containing a substantial amount of water, for example being adsorbed on or absorbed in fibers or other solid material of the lignin, which can correspondingly be in the form of a moist lignin cake. The presence of water in the lignin, however, is undesirable for a subsequent oxyalkylation between the lignin and a cyclic alkyl carbonate, because the water can react with catalyst and decrease the yield and efficiency of the reaction. Additionally, the presence of residual water remaining after the formation of the oxyalkylated lignin polyol can undesirably react with a subsequently added isocyanate compound to generate carbon dioxide and foaming instead of a desired polyurethane compound.

In a typical process, the lignin is dried to remove water prior to being combined with any oxyalkylation reactants or reagents, for example by heating a moist lignin cake in an oven or otherwise by exposure to hot air or other gases. This process is generally energy intensive, however, in particular when trying to achieve very low water levels in a dried lignin product, and it can require an additional heating/drying unit operation along with a reaction unit operation for oxyalkylation. For example, all lignin samples isolated either from black liquor (kraft), soda or from lignin cake (organosolv, biorefinery) all have a final step of washing with water, which means the lignin has to be dried. Even with drying, however, it can be difficult to achieve lignin water content values below 5 wt. %. Drying of lignin is difficult and expensive because it is energy intensive, requires a high capital investment, and creates a lot of dust. Additionally, lignin is hygroscopic can readily re-absorb water (e.g., water vapor from air) right after drying.

The disclosed method avoids the need for a separate drying step and can use an initial lignin material having a relatively high water content (or “wet lignin”). The wet lignin can be added directly to a liquid medium including a cyclic alkyl carbonate co-reactant for lignin oxyalkylation, for example in the reaction vessel in which the subsequent oxyalkylation will be performed. This initial reaction mixture containing the cyclic alkyl carbonate and the wet lignin is heated to a sufficiently high temperature, for example up to about 150° C. or 200° C., that vaporizes and removes the water from the reaction mixture, while still being below a boiling point or other temperature that would be sufficient to vaporize and remove the cyclic alkyl carbonate. The heating for water removal can be performed as a distillation process (e.g., a batch distillation in the reaction vessel). The heating is performed in the absence of an oxyalkylation or other catalyst in order to prevent or limit premature reactions, for example between oxyalkylation catalyst and water, the cyclic alkyl carbonate and lignin, or otherwise. Cyclic alkyl carbonates like propylene carbonate typically have limited solubility in water (e.g., about 5-8%), so the addition of the carbonate to wet lignin typically provides at least two different phases: a liquid carbonate phase, a (dispersed) water phase, and a dispersed solid lignin material (e.g., for lignins insoluble in the carbonate at ambient/room temperature) or a solubilized solid lignin material (e.g., for lignins soluble in the carbonate at ambient/room temperature). Even when the solid lignin material is initially relatively insoluble in the carbonate phase, heating of the reaction mixture to remove water will also increase the temperature sufficiently to solubilize the lignin. Solubilization of the lignin into the cyclic alkyl carbonate liquid medium facilitates water removal via heating or distillation by releasing water that is bound or otherwise associated with the initial wet lignin into the reaction mixture (e.g., as additional water in a dispersed aqueous phase). This is in contrast to heating of the wet lignin in an oven or otherwise heated gas atmosphere that can have difficulty in removing a sufficient amount of water down to desirable levels for oxyalkylation.

Once the water has been removed from the initial mixture of the cyclic alkyl carbonate and the wet lignin, oxyalkylation can be performed using an oxyalkylation catalyst as generally known in the art (e.g., a base catalyst). The catalyst is added to the reaction mixture after water removal, and the reaction mixture is heated for a sufficient time and at a temperature to react the cyclic alkyl carbonate with the lignin to form the oxyalkylated lignin polyol. In particular, the hydroxyl groups of lignin are reactive towards and can participate in a ring-opening transesterification reaction with the cyclic alkyl carbonate in the presence of a catalyst. This reaction forms an ester linking group between the hydroxyl groups of lignin and the ring-opened cyclic alkyl carbonate. This process is illustrated in Scheme 1 below for a generic lignin residue having an aromatic hydroxyl group reacting with propylene carbonate as a representative cyclic alkyl carbonate. Ring-opening transesterification with aliphatic hydroxyl groups and the cyclic alkyl carbonate can likewise occur, for example by reacting with native aliphatic hydroxyl groups in the lignin and/or by reacting with aliphatic hydroxyl groups appended to the lignin by an earlier transesterification step. This process is illustrated in Scheme 2 below as an extension of Scheme 1 in which oxyalkyl side chains with n+1 oxyalkyl groups/residues are appended to a lignin substrate, for example where the degree of oxyalkylation can be controlled or selected based on the relative amount of cyclic alkyl carbonate added, reaction time, reaction temperature, etc.

As illustrated in Schemes 1 and 2, the transesterification product includes a pendant aliphatic hydroxy group still linked to the carbonate. This oxyalkyl aliphatic hydroxy group, similar to the lignin aliphatic hydroxy groups, is relatively more reactive with isocyanate groups than aromatic hydroxyl groups of lignin. Accordingly, the generated pendant aliphatic hydroxy groups in the oxyalkylated lignin polyol reaction product are particularly suitable for the formation of a lignin-based polyurethane by reaction with a di- or higher functionality polyisocyanate.

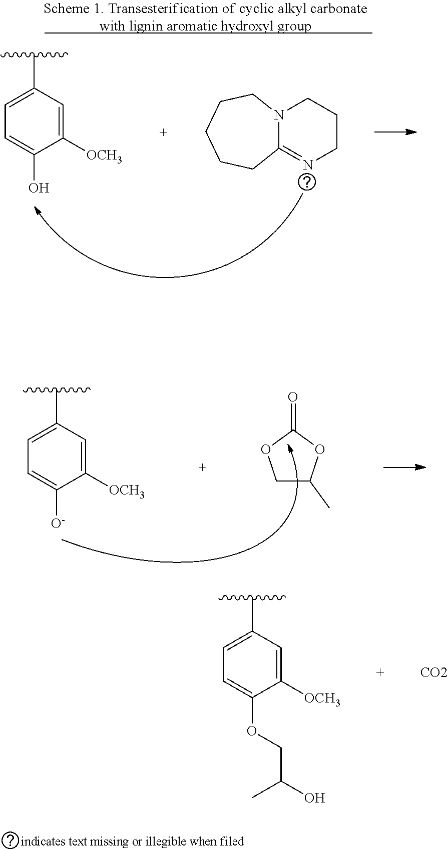

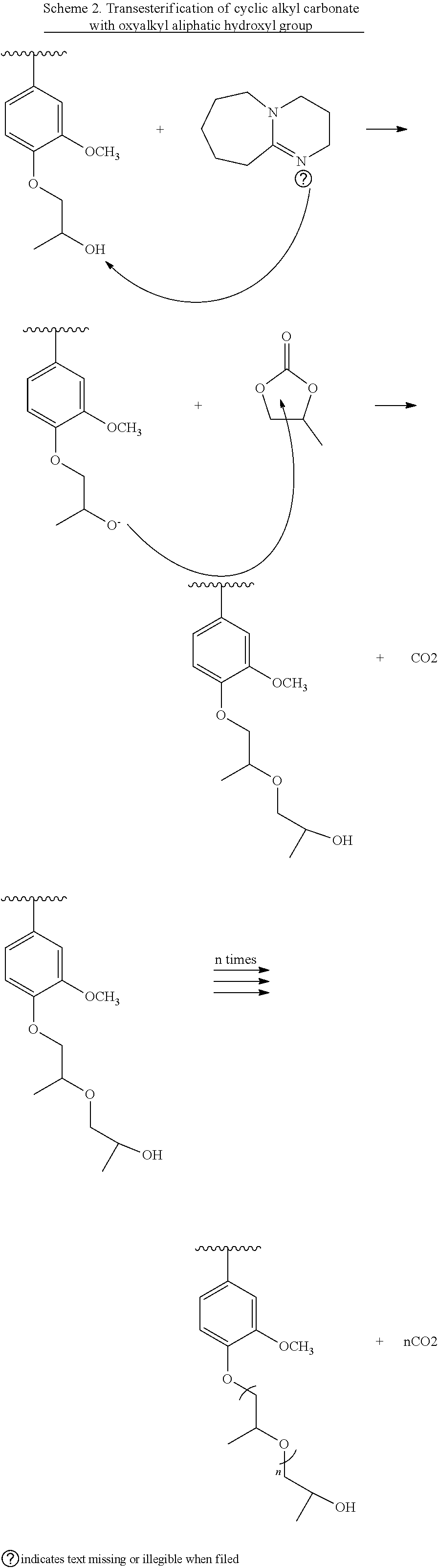

### Cyclic Alkyl Carbonate

The cyclic alkyl carbonate is not particularly limited and can include any cyclic structure including a carbonate group (—OC(═O)O—) linked to an alkyl hydrocarbon group at both carbonate oxygen atoms, thus forming a cyclic structure from five or more atoms (e.g., one carbonyl carbon atom, two carbonate oxygen atoms, and at least two alkyl carbon atoms). The cyclic alkyl carbonate suitably is in liquid form both at lower ambient temperatures (e.g., room temperature or about 20-30° C.) and/or at higher temperatures that may be useful reaction temperatures for prepolymerization and/or curing. For example, propylene carbonate has a melting point of −49° C. and a boiling point of 242° C. Similarly, ethylene carbonate has a melting point of 35° C. and a boiling point of 243° C., so it would be useful, for example, in a high-temperature formulation (i.e., where it is in liquid form) or in liquid solution with another cyclic alkyl carbonate that is liquid at lower ambient temperatures, such as propylene carbonate. The cyclic alkyl carbonate further suitably serves as a solvent for the lignin, thus assisting water removal via solubilization of the lignin and release of the lignin's water into the liquid cyclic alkyl carbonate (e.g., as a dispersed aqueous phase) for subsequent removal via heating or distillation. Different lignins have varying solubilities in the cyclic alkyl carbonate medium. For example, organosolv lignins are soluble in propylene carbonate at room temperature, while other lignins such as kraft are soluble in propylene carbonate at higher temperatures of about 100-120° C. In either case, the lignin is solubilized at temperatures suitable for water removal via heating.

In embodiments, the cyclic alkyl carbonate can have an alkyl group containing from 2 to 20 carbon atoms. For example, the cyclic alkyl carbonate can have at least 2, 3, 4, 5, or 6 and/or up to 3, 4, 5, 6, 8, 10, 12, 15, or 20 carbon atoms. The alkyl group can be linear or branched and/or substituted or unsubstituted. The alkyl group and the corresponding cyclic alkyl carbonate preferably does not include any free hydroxyl groups, free amine groups, and/or free carboxylic acid/carboxylate groups (e.g., when the alkyl group is a substituted group). The alkyl group does not include the carbon atom in the carbonyl group of the carbonate. Thus, the cyclic alkyl carbonate has 3 to 21 total carbon atoms in this embodiment. The alkyl group can be linked to the carbonate group oxygen atoms at adjacent carbon atoms (e.g., as in propylene carbonate with a 3-carbon alkyl group or ethylene carbonate with a 2-carbon alkyl group) or at non-adjacent carbon atoms (e.g., as in trimethylene carbonate with a 3-carbon alkyl group).

In embodiments, the cyclic alkyl carbonate has a structure according to Formula I illustrated below. In Formula I, n is 1 to 10; i is each of 1 to n; and Rᵢ, R′ᵢ, Rₙ₊₁, and R′ₙ₊₁ are independently selected from H and linear or branched, substituted or unsubstituted C₁-C₁₀ alkyl groups. In the illustrated Formula I, the index n can be a single value from 1 to 10, such as 1, 2, or 3, for example at least 1, 2, or 3 and/or up to 2, 4, 6, 8, or 10. The index i takes all of the values from 1 to n for a given value of n (i.e., there are “i” groups for each of the n+1 total carbons in the ring). Rᵢ, R′ᵢ, Rₙ₊₁, and R′ₙ₊₁ can independently be H or linear or branched, substituted or unsubstituted C₁-C₁₀ alkyl groups, such as alkyl groups with 1, 2, or 3 carbons, for example at least 1, 2, or 3 and/or up to 2, 4, 6, 8, or 10 carbons. Substituents for substituted alkyl groups are generally not limited, but preferably do not include isocyanate-reactive groups such as hydroxyl groups, amine groups (e.g., primary, secondary), and carboxylic acid/carboxylate groups. For example, if n=2, then the structure of Formula I will have R₁, R′₁, R₂, R′₂, R₃, and R′₃ substituents, which can be independently selected to be hydrogen atoms or the alkyl groups noted above. Examples of suitable cyclic alkyl carbonates include propylene carbonate, ethylene carbonate, trimethylene carbonate, butylene carbonates (e.g., derived from one or more butanediols such as 1,2-, 1,3-, 1,4-, or 2,3-butanediol), pentylene carbonates (e.g., derived from one or more pentanediols), etc. In the context of the structure of Formula I for propylene carbonate, n is 1; R₁, R′₁, and R′₂ are H; and R₂ is CH₃. For ethylene carbonate, n is 1; and R₁, R′₁, R₂, and R′₂ are H. For trimethylene carbonate, n is 2; and R₁, R′₁, R₂, R′₂, R₃, and R′₃ are H.

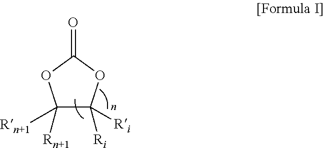

The cyclic alkyl carbonate can be added to the reaction mixture in controlled or selected amount (e.g., relative to the lignin) in order to obtain an oxyalkylated lignin polyol product with one or more of a desired aliphatic hydroxyl content (e.g., mmol aliphatic OH/g), overall hydroxy value (e.g., mg KOH/g), and/or viscosity (e.g., cP measured at 25° C.). In embodiments, the cyclic alkyl carbonate can be added to or present in the reaction mixture in an amount in a range of 2 eq to 10 eq relative to the lignin hydroxyl content. For example, the cyclic alkyl carbonate can be present in the reaction mixture in an amount of at least 2, 2.5, 3, 3.5, 4, or 5 eq and/or up to 3, 4, 5, 6, 7, 8, or 10 eq relative to the lignin hydroxyl content. The molar equivalent “eq” unit represents in this case moles of cyclic alkyl carbonate molecules or moles of total hydroxyl (—OH) groups initially in the lignin, which represents the sum of phenolic/aromatic hydroxyl, aliphatic hydroxyl groups, and carboxylic acid hydroxyl groups initially in the lignin. Alternatively or additionally, the content of the reaction mixture can be expressed on a weight basis, for example containing 50-95 wt. % (e.g., at least 50, 60, or 70 wt. % and/or up to 70, 80, 90, or 95 wt. %) cyclic alkyl carbonate and 5-50 wt. % lignin (e.g., at least 5, 10, 15, 20, or 25 wt. % and/or up to 20, 30, 40, or 50 wt. %) (dry weight basis) based on the combined amount of cyclic alkyl carbonate and lignin (dry weight basis). There is generally no need to add solvents or other components to the reaction mixture, such that the (initial) reaction mixture is typically at least 95, 98, 99, or 99.5 wt. % of cyclic alkyl carbonate, lignin, and water combined, based on the combined weight of the reaction mixture.

### Lignin

The lignin is not particularly limited and generally can include lignin from any lignocellulosic biomass. Plants, in general, are comprised of cellulose, hemicellulose, lignin, extractives, and ash. Lignin typically constitutes 15-35 wt. % of woody plant cell walls, is an amorphous aromatic polymer made of phenylpropane units (e.g., coniferyl alcohol, sinapyl alcohol, p-coumaryl alcohol). The lignin for use according to the disclosure is not particularly limited to the source of lignin or its isolation method. Any type of lignin regardless of the biomass type (hardwood, softwood, grasses, and other agricultural residues) isolated through any extraction methods (such as Kraft, soda, organosolv, sulfite, enzymatic hydrolysis, ionic liquid, sulfite) is suitable for use in the disclosed compositions and articles.

The lignin incorporated into the reaction mixture for oxyalkylation is generally an unmodified lignin. Unmodified lignin as used herein refers to lignin that has been separated from other components of its lignocellulosic biomass feedstock, such as the cellulose, hemicellulose, and other plant material components. Such separation processes (e.g., Kraft, soda, organosolv, sulfite, enzymatic hydrolysis, and ionic liquid) to isolate lignin from biomass may hydrolyze or otherwise fragment larger lignin molecules into smaller fragments, but this fragmentation and molecular weight reduction is still considered to provide an unmodified lignin as used herein in the corresponding compositions and methods. Such isolated lignins, which are also known as technical lignins, have not been subjected to further modifications or fragmentations, and are considered to provide an unmodified lignin as used herein in the corresponding compositions and methods. Modifications (or chemical modifications) that are generally avoided for the lignin used herein can include one or more of demethylation, phenolation, hydroxymethylation, etherification, depolymerization, and fractionation to monomer, dimers, trimers and oligomers.

The unmodified lignin is generally polymeric, as contrasted with various lignin monomers such as one or more of coniferyl alcohol, sinapyl alcohol, and p-coumaryl alcohol. For example, the unmodified lignin can have an average molecular weight (e.g., weight-average molecular weight, Mw) of at least 500 g/mol or at least 1000 g/mol. While technical lignins or other commercial lignins isolated from biomass could have some lignin monomers in the distribution of lignin components, the fraction of such lignin monomers in the unmodified lignin is suitably small, for example as reflected by the minimum average molecular weight of the unmodified lignin. In some embodiments, the unmodified lignin contains less than 10, 5, 2, 1, 0.5, 0.2, or 0.1 wt. % lignin monomers relative to the total unmodified lignin.

In embodiments, the (unmodified) lignin, prior to incorporation into the reaction mixture, can have at least one of the following properties: a molecular weight in a range of 500 to 20000; a polydispersity in a range of 1.2 to 8; an aliphatic hydroxyl content in a range of 1 to 4 mmol/g; a phenol hydroxyl content in a range of 2 to 5 mmol/g; a carboxylic hydroxyl content less than 1 mmol/g; and a total hydroxyl content in a range of 3 to 9 mmol/g.

In embodiments, the (unmodified) lignin, prior to incorporation into the reaction mixture, can have the following properties: a number-average molecular weight (Mn) in a range of 500 to 5000 (or 1000 to 3000); a polydispersity in a range of 1.2 to 8 (or 2 to 4); a phenol hydroxyl content in a range of 1 to 7 mmol/g (or 2 to 5 mmol/g); a relative phenol hydroxyl content of at least 45% (or at least 55%) relative to hydroxyl groups of the unmodified lignin; and a carboxylic hydroxyl content less than 1 mmol/g (or less than 0.5 mmol/g).

More generally, the (unmodified) lignin, prior to reaction and/or incorporation into a reaction mixture for removal of water, suitably can be selected to have one or more properties related to molecular weight, molecular weight distribution, hydroxyl content, and hydroxyl content distribution. For example, a lower molecular weight and/or a lower polydispersity index can be desirable to promote access to and reactivity of the phenolic (or aromatic) hydroxy groups of the lignin, but lignin with any molecular weight and/or polydispersity can be used. Suitably, the weight-average molecular weight (M_{w}) can be in a range of 500 to 50000, 1000 to 3000, 3000 to 7000, 3000 to 10000, or 10000 to 50000. For example, M_{w} independently can be at least 500, 800, 1000, 1500, 2000, or 3000 and/or up to 1000, 1200, 1500, 2000, 3000, 5000, 7000, 10000, 15000, or 50000, but higher values are possible. Similar ranges can apply to the number-average molecular weight (Mₙ). Alternatively or additionally, the polydispersity index (M_{w}/Mₙ) can be in a range of 1.2 to 10, 1.2 to 8, 1.2 to 5, or 2 to 4, for example being at least 1.2, 1.4, 1.6, 1.8, or 2 and/or up to 1.5, 1.8, 2.0, 3.0, 4.0, 5.0, 6.0, 8.0, or 10, but higher values are possible. In a refinement, the aliphatic hydroxyl content of the unmodified lignin can be in a range of 0.5 to 7 mmol/g, 1 to 4 mmol/g, or 1 to 3 mmol/g, for example being at least 0.5, 1, 1.5 or 2 and/or up to 2, 2.5, 3, 3.5, 4, 5, 6, or 7 mmol/g. In a refinement, the phenol hydroxyl content of the unmodified lignin can be in a range of 1 to 7 mmol/g, 2 to 6 mmol/g, or 3 to 6 mmol/g, for example being at least 1, 1.5, 2, 2.5, 3, or 3.5 and/or up to 3, 3.5, 4, 4.5, 5, 5.5, 6, or 7 mmol/g. Alternatively or additionally, the phenol hydroxyl content can be at least 40, 50, 60, or 70% and/or up to 60, 65, 70, 75, or 80% of the total hydroxyl groups of the unmodified lignin (e.g., aliphatic, phenolic/aromatic, and carboxylic hydroxyl groups combined). Similarly, the phenol hydroxyl content individually can be greater than the aliphatic hydroxyl content individually and the carboxylic hydroxyl content individually. In a refinement, the carboxylic hydroxyl content of the unmodified lignin can be less than 1 mmol/g or 2 mmol/g, for example being at least 0.01, 0.1, or 0.2 and/or up to 0.2, 0.3, 0.4, 0.5, 0.7, 1, 1.5, or 2 mmol/g. In a refinement, the total hydroxyl content of the unmodified lignin can be in a range of 2 to 10 mmol/g, 3 to 9 mmol/g, or 4 to 7 mmol/g, for example being at least 2, 2.5, 3, 3.5, 4, 4.5, or 5 and/or up to 3.5, 4, 4.5, 5, 6, 7, 8, 9, or 10 mmol/g.

As described above, the lignin added to the reaction mixture need not be (and suitably is not) dried before being used in the disclosed methods. For example, the lignin initially in or added to the reaction mixture can have a water content of 5 wt. % to 70 wt. % (e.g., 10 wt. % to 50 wt. %) relative to the lignin (dry weight basis). More generally, the wet lignin initially in or added to the reaction mixture can have a water content of at least 1, 2, 5, 10, 15, 20, 25, 30, 40, or 50 wt. % and/or up to 20, 30, 40, 50, 60, 70, 80, or 100 wt. % relative to the lignin (dry weight basis). Alternatively or additionally, the wet lignin initially in or added to the reaction mixture can have a water content of at least 2, 5, 10, 15, 20, or 25 wt. % and/or up to 20, 30, 40, or 50 wt. % relative to the total of lignin and water (wet weight basis).

### Method and Oxyalkylated Lignin Polyol Product

As described above, the initial reaction mixture can be formed by any suitable mixing or blending process, such as by adding the wet lignin directly to a liquid medium including a cyclic alkyl carbonate co-reactant for lignin oxyalkylation, for example in the reaction vessel in which the subsequent oxyalkylation will be performed. The initial reaction mixture is generally a multiphase mixture, typically including a liquid carbonate phase (e.g., as a continuous medium) and a water phase (e.g., as a dispersed phase). Depending on the solubility of the lignin in the carbonate, the lignin can be present as a dispersed solid lignin material (e.g., for lignins insoluble in the carbonate at ambient/room temperature) or a solubilized solid lignin material (e.g., for lignins soluble in the carbonate at ambient/room temperature).

Dehydration of the reaction mixture can be performed using any suitable heating or distillation process. For example, the method can include heating the reaction mixture to remove the water at a temperature in a range of 100° C. to 230° C. The heating more generally is performed at an elevated temperature sufficient to vaporize and remove water from the reaction mixture, but at a temperature low enough to avoid substantial vaporization and removal of the cyclic alkyl carbonate from the reaction mixture. Accordingly, suitable heating temperatures for water removal can be in the range of 100° C. to 230° C., for example at least 100, 120, 130, 150, 170, or 200° C., and/or up to 150, 160, 180, 200, 220, or 230° C., and/or up to a temperature that is 5-20° C., 20-40° C., or 40-60° C. below the boiling point of the cyclic alkyl carbonate. Suitable heating times (or residence times in a continuous system) can be in the range of 0.25-24 hr, 0.5-12 hr, or 1-6 hr.

After water removal, the dehydrated reaction mixture typically has a water content of 0.1, 0.2, or 0.5 wt. % or less, relative to the lignin (dry weight basis). For example, the dehydrated reaction mixture can have a water content of at least 0.001, 0.01, or 0.1 wt. % and/or up to 0.1, 0.2, 0.3, 0.4, 0.5, 0.6, 0.8, or 1 wt. % relative to the lignin (dry weight basis). Alternatively or additionally, the dehydrated reaction mixture can have a water content of at least 0.0001, 0.001, 0.01, or 0.03 wt. % and/or up to 0.03, 0.05, 0.07, 0.1, 0.15, 0.2, 0.3, or 0.4 wt. % relative to the dehydrated reaction mixture as a whole.

The oxyalkylation catalysts useful according to the disclosure are not particularly limited and can generally include base catalysts (e.g., strong bases or super bases), for example those known for use in transesterification reactions. Examples include 1,8-diazabicyclo[5.4.0]undec-7-ene (DBU), 1,5,7-Triazabicyclo[4.4.0]dec-5-ene, 1,4-diazabicyclo[2.2.2]octane (DABCO), potassium tert-butoxide, tetra-n-butylammonium bromide (TBAB) (phase transfer catalyst), potassium carbonate, pyridine, and triethylene amine.

The initial reaction mixture prior to heating to remove water is suitably free or substantially free of any oxyalkylation catalyst, for example not having any added oxyalkylation catalyst (e.g., no initial added amount of the oxyalkylation catalyst that is added after water removal). In embodiments, the reaction mixture contains less than 0.01, 0.001, 0.0001, or 0.00001 wt. % of any oxyalkylation catalysts, based on the combined or total weight of the reaction mixture. Similar amounts and ranges for the catalyst apply as well to the dehydrated reaction mixture prior to catalyst addition.

In embodiments, the oxyalkylation catalyst is added to the dehydrated reaction mixture in an amount in a range of 0.01 eq to 0.2 eq relative to the lignin hydroxyl content. For example, the oxyalkylation catalyst can be added to or otherwise present in the dehydrated reaction mixture in an amount of at least 0.01, 0.02, 0.03, 0.04, or 0.05 eq and/or up to 0.06, 0.08, 0.1, 0.15, or 0.2 eq relative to the lignin hydroxyl content. The molar equivalent “eq” unit represents in this case moles of oxyalkylation catalyst molecules or moles of total hydroxyl (—OH) groups initially in the lignin, which represents the sum of phenolic/aromatic hydroxyl, aliphatic hydroxyl groups, and carboxylic acid hydroxyl groups initially in the lignin.

Oxyalkylation of the lignin in the dehydrated reaction mixture after catalyst addition can be performed using any suitable heating process. The oxyalkylation reaction can be performed at an elevated temperature (e.g., above 100° C.) to improve the rate and yield of the transesterification reaction, thereby improving the conversion of aromatic hydroxyl groups and to aliphatic hydroxyl groups in the oxyalkylated lignin polyol reaction product. Suitable reaction temperatures for the oxyalkylation reaction can be in the range of at least 100, 110, 120, 130, or 140° C. and/or up to 120, 140, 150, 160, 170, 180, or 200° C. Suitable reaction times (or residence times in a continuous system) can be in the range of 0.25-24 hr, 0.5-12 hr, or 1-6 hr, for example about 3 hr.

In embodiments, the oxyalkylation reaction can be performed in a sealed reaction vessel or pressure vessel, typically at a pressure above ambient or environmental pressure to prevent any inflow of air from the external environment. Performing the reaction in a sealed reaction vessel limits or prevents the loss of cyclic alkyl carbonate reactant during the reaction, thus improving conversion and yield for a given amount of added cyclic alkyl carbonate. Although the reaction temperature is generally below the boiling point of the cyclic alkyl carbonate (e.g., about 242° C. for propylene carbonate), the reaction temperature and corresponding vapor pressure of the cyclic alkyl carbonate is high enough to result in some vaporization and loss of the reactant in a reaction vessel open to the environment. Suitable reaction pressures can be in a range of 0.03-1 bar (about 0.5-15 psi), for example at least 0.03, 0.06, 0.1, 0.2, or 0.3 bar and/or up to 0.3, 0.5, 0.7, or 1 bar above ambient or environmental pressure (or a gauge pressure). The internal gaseous headspace in the reactor above the liquid reaction medium is suitably any inert or non-oxygen-containing gas such as nitrogen gas.

In embodiments, carbon dioxide produced during the oxyalkylation reaction can be vented from the sealed reaction vessel. Carbon dioxide is a byproduct of the oxyalkylation reaction as shown in Schemes 1 and 2. Accumulation of carbon dioxide in the reaction system is undesirable, because it can create excessive pressures in the reaction vessel as well as increased concentrations of carbon dioxide in the liquid reaction medium. Carbon dioxide in the liquid reaction medium can neutralize and deactivate base catalyst compounds such as DBU serving as the oxyalkylation catalyst, thus limiting overall conversion. Thus in some embodiments, it can be desirable to periodically vent accumulated carbon dioxide in the reaction vessel headspace to reduce the overall carbon dioxide in the reaction system. After venting, the reaction system is returned to a closed or sealed state while the reaction continues, thus limiting possible loss of the cyclic alkyl carbonate during the reaction.

In embodiments, additional cyclic alkyl carbonate and/or additional oxyalkylation catalyst can be added to the dehydrated reaction mixture while performing the oxyalkylation reaction. As described above, the oxyalkylation catalyst can become ineffective during the course of an oxyalkylation reaction due to accumulation of carbon dioxide and catalyst deactivation, even with venting to remove carbon dioxide. In such cases, additional amounts of cyclic alkyl carbonate and fresh oxyalkylation catalyst can be added to the reaction vessel after starting the reaction with the initial cyclic alkyl carbonate and oxyalkylation catalyst. For example, evolution of carbon dioxide during the reaction can be monitored as an indicator of rate of reaction; when the rate of reaction drops significantly or stops, the additional cyclic alkyl carbonate and fresh oxyalkylation catalyst can be added to resume the reaction. Addition of the cyclic alkyl carbonate in separate aliquots in this manner also maintains a relatively lower excess of the carbonate, which in turn promotes reaction with the lignin instead of carbonate-carbonate self-polymerization.

The disclosed method can provide an oxyalkylated lignin polyol reaction product having an aliphatic hydroxy content, overall hydroxy value, and/or viscosity that can be selected within a relatively wide range depending on a desired end use for the oxyalkylated lignin polyol. For example, oxyalkylated lignin polyols having relatively high aliphatic hydroxy contents (e.g., about 3 to 6 mmol/g) are particularly suitable for forming rigid polyurethane foams, because the high aliphatic hydroxy content provides many isocyanate-reactive sites that can in turn provide a high crosslinking density in a corresponding polyurethane polymer. Similarly, oxyalkylated lignin polyols having relatively low aliphatic hydroxy contents (e.g., about 0.5 to 2 mmol/g) are particularly suitable for forming flexible polyurethane foams or elastomers, because the low aliphatic hydroxy content provides sufficient isocyanate-reactive sites for polymerization, but not so many that would result in a highly crosslinked polyurethane polymer.

In embodiments, the oxyalkylated lignin polyol reaction product can have an aliphatic hydroxy content in a range of 0.2 mmol/g to 6 mmol/g. For example, the oxyalkylated lignin polyol can have an aliphatic hydroxy content of at least 0.2, 0.3, 0.5, 0.6, 0.8, 1, 1.2, 1.5, 1.7, 2, 2.5, 3, 3.5, or 4 mmol/g and/or up to 0.7, 1, 1.2, 1.5, 1.8, 2, 2.5, 3, 3.5, 4, 4.5, 5, 5.5, or 6 mmol/g. Alternatively or additionally, the oxyalkylated lignin polyol reaction product can have a hydroxy value in a range of 20 to 400 mg KOH/g or 40 to 200 mg KOH/g. For example, the oxyalkylated lignin polyol can have a hydroxy value of at least 20, 30, 40, 60, 80, or 100 mg KOH/g and/or up to 50, 75, 100, 150, 200, 300, or 400 mg KOH/g. Alternatively or additionally, the oxyalkylated lignin polyol reaction product can be a liquid at ambient temperatures (e.g., at 20-30° C.) and have a viscosity at 25° C. and shear rate of 1000 s⁻¹ (1000 μm gap) in a range of 5 to 2000000 cP. For example, the oxyalkylated lignin polyol can have a viscosity at 25° C. and shear rate of 1000 s⁻¹ (1000 μm gap) of at least 5, 10, 20, 50, 100, 200, 500, 1000, 2000, 5000, or 10000 cP and/or up to 1500, 3000, 5000, 10000, 20000, 50000, 100000, 200000, 500000, 10000000, or 2000000 cP.

The oxyalkylation reaction can convert essentially all aromatic hydroxy and carboxylic acid groups in the original lignin to aliphatic hydroxy groups. For example, the oxyalkylated lignin polyol reaction product can be free or substantially free of aromatic hydroxy groups and/or carboxylic acid groups, such as having 0.001, 0.01, or 0.1 mmol/g or less aromatic hydroxy groups and/or carboxylic acid groups. Typically at least some of the original aliphatic hydroxy groups in the lignin also react via the oxyalkylation reaction such that the aliphatic hydroxy content in the oxyalkylated lignin polyol reaction product includes at least the oxyalkylated aliphatic hydroxy groups, but possibly also some remaining unreacted original aliphatic hydroxy groups in the lignin. The total number of hydroxy groups (e.g., aromatic, carboxylic, and aliphatic hydroxy groups combined) in a given molecule is generally conserved during the oxyalkylation reaction, but the overall molecular weight is generally increased with the addition of oxyalkyl groups, thus resulting in a lower total hydroxy group content on a per mass basis between the original lignin and the final oxyalkylated lignin polyol.

### Polyol-Based Polymers

The oxyalkylated lignin polyol according to the disclosure can be used to form any of a variety of polyol-based polymers according to methods generally known in the art. Namely, the polyhydroxy functionality of the oxyalkylated lignin polyol is useful as a first comonomer to react with a hydroxy-reactive second comonomer to form a corresponding polymer or copolymer, for example a thermoplastic, networked, crosslinked, or thermoset (co)polymers. Common examples include polyurethanes and polyesters, which can be formed by reacting the oxyalkylated lignin polyol with an isocyanate (or polyisocyanate) or an organic acid (or polyacid), respectively.

For example, an isocyanate (e.g., diisocyanate) can be added to the oxyalkylated lignin polyol reaction product, and the isocyanate/polyol mixture can be reacted to form a polyurethane polymer. An advantage of the disclosed process is that oxyalkylated lignin polyol as originally formed is suitable for further reaction to form a corresponding polyurethane directly in the same reaction vessel used for both water removal and oxyalkylation (e.g., as a one-pot synthesis starting from wet lignin). The polyurethane can be a highly crosslinked thermoset, a lightly or non-crosslinked polymer, elastomer, etc. depending on the hydroxy content of the oxyalkylated lignin polyol and the functionality of the isocyanate. Typically, the base catalysts that are suitable as oxyalkylation catalysts also catalyze the reaction between the oxyalkylated lignin polyol and the isocyanates, so any residual catalyst remaining after oxyalkylation is generally sufficient for polyurethane formation. In some cases, due to the generally higher rate of reaction for the polyurethane formation, it can be desirable to neutralize some of the residual catalyst remaining after oxyalkylation (i.e., lowering the amount of active catalyst but retaining at least some active catalyst).

The isocyanate is not particularly limited and generally can include any aromatic, alicyclic, and/or aliphatic monomeric, oligomeric, and/or polymeric isocyanates having at least two reactive isocyanate groups (—NCO) (e.g., di- or higher poly-functional isocyanates). Suitable isocyanates contain on average 2-4 isocyanate groups. In some embodiments, the isocyanate includes a diisocyanate. In some embodiments, the isocyanate includes triisocyanate. Suitable diisocyanates can have the general structure (O═C═N)—R—(N═C═O), where R can include aromatic, alicyclic, and/or aliphatic groups, for example having at least 2, 4, 6, 8, 10 or 12 and/or up to 8, 12, 16, or 20 carbon atoms. Examples of specific isocyanates include 1,5-naphthylene diisocyanate, 4,4′-diphenylmethane diisocyanate (MDI), hydrogenated MDI, polymeric methylene diphenyl diisocyanate (pMDI), xylene diisocyanate (XDI), tetramethylxylol diisocyanate (TMXDI), 4,4′-diphenyl-dimethylmethane diisocyanate, di- and tetraalkyl-diphenylmethane diisocyanate, 4,4′-dibenzyl diiso-cyanate, 1,3-phenylene diisocyanate, 1,4-phenylene diisocyanate, one or more isomers of tolylene diisocyanate (TDI, such as toluene 2,4-diisocyanate), 1-methyl-2,4-diiso-cyanatocyclohexane, 1,6-diisocyanato-2,2,4-trimethyl-hexane, 1,6-diisocyanato-2,4,4-trimethylhexane, 1-iso-cyanatomethyl-3-isocyanato-1,5,5-trimethylcyclohexane, chlorinated and brominated diisocyanates, phosphorus-containing diisocyanates, 4,4′-diisocyanatophenyl-perfluoroethane, tetramethoxybutane 1,4-diisocyanate, butane 1,4-diisocyanate, hexane 1,6-diisocyanate (or hexamethylene diisocyanate; HDI), HDI dimer (HDID), HDI trimer (HDIT), HDI biuret, dicyclohexylmethane diisocyanate, cyclohexane 1,4-diisocyanate, ethylene diisocyanate, phthalic acid bisisocyanatoethyl ester, 1-chloromethylphenyl 2,4-diisocyanate, 1-bromomethylphenyl 2,6-diisocyanate, 3,3-bischloromethyl ether 4,4′-diphenyldiisocyanate, trimethylhexamethylene diisocyanate, 1,4-diisocyanato-butane, 1,2-diisocyanatododecane, and combinations thereof. The isocyanate can be biobased or made of synthetic feedstock. Examples of suitable biobased isocyanates include pentamethylene diisocyanate trimer, and isocyanates formed from base compounds to which isocyanate groups are attached (e.g., via suitable derivatization techniques), including isocyanate-terminated poly(lactic acid) having two or more isocyanate groups, isocyanate-terminated poly(hydroxyalkanaotes) having two or more isocyanate groups, isocyanate-terminated biobased polyesters having two or more isocyanate groups.

Similarly, an organic acid with carboxylic acid/carboxylate functionality (e.g., diacid) can be added to the oxyalkylated lignin polyol reaction product, and the acid/polyol mixture can be reacted to form a polyester polymer. This is analogous to the polyurethane formation as described above, but using an organic di- or higher-functional acid to form a corresponding polyester. Examples of suitable organic acids include alkyl and/or aryl acids such as terephthalic acid, maleic acid, and fumaric acid.

### EXAMPLES

The following examples illustrate the disclosed compositions and methods, but are not intended to limit the scope of any claims thereto.

### Example 1: Oxyalkylation of Softwood/Kraft Lignin

Different methods were used to oxyalkylate softwood/kraft lignin with a total (initial) hydroxyl content of 5.75 mmol/g and aliphatic hydroxyl value before modification of 98.2 mg KOH/g. In this example, pre-dried lignin was used to demonstrate the oxyalkylation step, but wet lignin could be used in combination with an initial dehydration step as generally described above.

Method 1: 10 g oven dried lignin is mixed with PC (propylene carbonate) (5 eq of total hydroxyl content of lignin, 29.35 g PC). Then, 0.05 eq of total hydroxyl content of lignin (0.438 g) DBU (1,8-diazabicyclo [5.4.0] undec-7-ene) catalyst is added to the mixture. Then the mixture is transferred to the Parr pressure reactor and nitrogen is purged for 5 min to completely remove moisture and air. The pressure of the reactor is adjusted to 1-2 psi (i.e., a low over pressure avoids or prevents entering air). The mixture is mixed for 3 hours at 150° C. Since carbon dioxide is released during the reaction, the internal reactor pressure increases and the gas outlet valve is opened periodically to decrease the pressure. After 3 hours, the heater is turned off and the reaction system is allowed to sit/cool until the temperature drops to around 50-70° C. For lignin characterization (for example measuring molecular weight), 10 fold HCl solution with pH 4 is added to the mixture. Precipitated lignin is centrifuged or filtered and washed several times (at least three times) and then dried at vacuum oven at 40° C. for 24-48 hours. To use modified oxyalkylated lignin product in the solution directly as a polyol, 0.17 g glacial acetic acid is added to the mixture and mixed at room temperature for 30 min, where acetic acid is used to neutralize any remaining base (DBU) catalyst in the system (e.g., thus allowing addition of an isocyanate or other comonomer for polymerization with the polyol). The oxyalkylated lignin polyol reaction product had an aliphatic hydroxyl value after modification of 189 mg KOH/g.

Method 2: The same procedure as described for Method 1 is used, except that the base catalyst is potassium tert-butoxide, which is added in an amount of 0.075 eq of total hydroxyl content (0.484 g). The oxyalkylated lignin polyol reaction product had an aliphatic hydroxyl value after modification of 192 mg KOH/g.

Method 3: The same procedure as described for Method 1 is used, except that the base catalyst is 1,5,7-triazabicyclo[4.4.0] dec-5-ene, which is added in an amount of 0.075 eq of total hydroxyl content (0.600 g). The oxyalkylated lignin polyol reaction product had an aliphatic hydroxyl value after modification of 190 mg KOH/g.

Method 4: The general procedure of Method 1 is extended to include multiple additions of carbonate reactant and base catalyst during the reaction. Initially, 10 g oven dried lignin, 29.35 g PC, and 0.05 eq of total hydroxyl content of lignin (0.438 g) DBU catalyst are used as the initial reaction mixture. The initial reaction mixture is heated/mixed at 150° C. for 4 h. Then, an additional 29.35 g PC, and 0.438 g DBU are added, and the reaction mixture is heated/mixed at 140° C. for an additional 4 h. The oxyalkylated lignin polyol reaction product had an aliphatic hydroxyl value after modification of 152 mg KOH/g.

Method 5: The same procedure as described for Method 1 is used, except that 1 g tetra-n-butylammonium bromide (TBAB) as a phase catalyst transfer is added to the reaction mixture along with the DBU catalyst. Further, the reaction mixture was mixed at 120° C. to perform the oxyalkylation reaction. The oxyalkylated lignin polyol reaction product had an aliphatic hydroxyl value after modification of 32 mg KOH/g.

Method 6: The same procedure as described for Method 1 is used, except that 0.025 eq of total hydroxyl content (0.219 g) DBU and 0.05 eq of total hydroxyl content (0.227 g) pyridine are used a base catalysts in combination. The oxyalkylated lignin polyol reaction product had an aliphatic hydroxyl value after modification of 182 mg KOH/g.

### Example 2: Oxyalkylation of Hardwood/Orbanosolv Lignin

The following method was used to oxyalkylate hardwood/organosolv lignin with a total (initial) hydroxyl content of 4.51 mmol/g and aliphatic hydroxyl value before modification of 77.5 mg KOH/g. In this example, pre-dried lignin was used to demonstrate the oxyalkylation step, but wet lignin could be used in combination with an initial dehydration step as generally described above.

Method 1: The same procedure as described for Example 1/Method 1 is used, except that 23.02 g PC (5 eq of total hydroxyl content of lignin) and 0.343 g DBU (0.05 eq of total hydroxyl content of lignin) are used. Further, the reaction is performed for 30 minutes at 150° C. The oxyalkylated lignin polyol reaction product had an aliphatic hydroxyl value after modification of 205 mg KOH/g.

### Example 3: Oxyalkylation of Wheat Straw/Soda Lignin

The following method was used to oxyalkylate wheat straw/soda lignin with a total (initial) hydroxyl content of 5.79 mmol/g and aliphatic hydroxyl value before modification of 84.15 mg KOH/g. In this example, pre-dried lignin was used to demonstrate the oxyalkylation step, but wet lignin could be used in combination with an initial dehydration step as generally described above.

Method 1: The same procedure as described for Example 1/Method 1 is used, except that 29.55 g PC (5 eq of total hydroxyl content of lignin) and 0.441 g DBU (0.05 eq of total hydroxyl content of lignin) are used. Further, the reaction is performed for 2 h at 150° C. The oxyalkylated lignin polyol reaction product had an aliphatic hydroxyl value after modification of 202 mg KOH/g.

### Example 4: Oxyalkylation of Hardwood/Kraft Lignin

The following method was used to oxyalkylate hardwood/kraft lignin with a total (initial) hydroxyl content of 5.73 mmol/g and aliphatic hydroxyl value before modification of 61.15 mg KOH/g. In this example, pre-dried lignin was used to demonstrate the oxyalkylation step, but wet lignin could be used in combination with an initial dehydration step as generally described above.

Method 1: The same procedure as described for Example 1/Method 1 is used, except that 29.25 g PC (5 eq of total hydroxyl content of lignin) and 0.436 g DBU (0.05 eq of total hydroxyl content of lignin) are used. Further, the reaction is performed for 1 h at 150° C. The oxyalkylated lignin polyol reaction product had an aliphatic hydroxyl value after modification of 193 mg KOH/g.

### Example 5: Oxyalkylation of Wet Softwood/Kraft Lignin

The following method is used to oxyalkylate wet softwood/kraft lignin with a 40 wt. % water content, a total (initial) hydroxyl content of 5.73 mmol/g.

Method 1: The same procedure as described for Example 1/Method 1 is used, except that 16.67 g wet lignin with a 40 wt % moisture content (i.e., 10 g lignin on a dry basis) is combined with the 29.35 g PC (5 eq of total hydroxyl content of lignin). Prior to addition of the DBU catalyst, the lignin/PC mixture is mixed and heated at 120° C. for 1 h with the gas outlet valve open on the Parr reactor to release water vapor. Then, 0.436 g DBU (0.05 eq of total hydroxyl content of lignin) is added and the remainder of the procedure is as described above for Example 1/Method 1.

### Example 6: Oxyalkylation of Softwood/Kraft Lignin with Controlled Properties

This example illustrates that the molar ratio (or equivalent ratio) of lignin to propylene carbonate (PC) can be adjusted to reach a specific hydroxyl value and/or viscosity of the oxyalkylated lignin polyol product for different applications. The reactions were performed according to the general procedures disclosed herein and with a selected molar or equivalent ratio for lignin:PC. Table 1 shows that by decreasing the PC amount, the hydroxyl value of oxyalkylated lignin polyol was increased significantly. Samples prepared with lignin/PC ratios of 1 and 2 (sample numbers 5 and 6 in Table 1) were not soluble in organic solvents, and their hydroxy values (OHVs) could not be measured. Table 1 further illustrates that a lower amount of PC forms a higher viscosity polyol. Samples 1 and 2 with lignin/PC ratios of 10 and 5, respectively, were fully soluble in commercially available polyols for flexible foam systems, while lower ratios showed low solubility. In addition, all samples except sample 6, were soluble in low molecular weight polyethylene glycol (PEG 200 and 400), and they could be used as co-polyol/co-solvent to improve the solubility of lignin polyol.

TABLE 1
Properties of lignin polyol samples prepared
with different PC/Lignin ratios

| | | PC/Lignin | | Viscosity cP |
|---|---|---|---|---|
| Sample | Lignin Type | ratio (mol) | OHV (mgKOH/g) | (25° C.) |
| 1 | Softwood kraft | 10 | 42 | 72 |
| 2 | Softwood kraft | 5 | 102 | 1300 |
| 3 | Softwood kraft | 4 | 144 | 5800 |
| 4 | Softwood kraft | 3 | 168 | 412000 |
| 5 | Softwood kraft | 2 | Sample was not | 1280000 |
| | | | soluble in organic | |
| | | | solvents | |
| 6 | Softwood kraft | 1 | Sample was not | Solid |
| | | | soluble in organic | |
| | | | solvents | |

Additionally, it was found that reaction time could be selected to control final polyol properties. It was found that a longer reaction time (for example, 8 hours) is needed to reach low OHV lignin polyol for flexible applications (lower OHV), while a relatively short reaction time (0.5-3 hours depending on lignin source) is used for rigid applications (coating, adhesive, and rigid foam). Other cyclic carbonates, including ethylene carbonate and butylene carbonate, were tested for their ability to form oxyalkylated lignin polyols, and their reaction products showed similar properties to polyols formed from propylene carbonate.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, kits, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

1. A method for forming an oxyalkylated lignin polyol, the method comprising:
providing a reaction mixture comprising:
a cyclic alkyl carbonate, and
a lignin comprising water in an amount of at least 1 wt. % relative to the lignin,
wherein the reaction mixture is substantially free from an oxyalkylation catalyst;
heating the reaction mixture for a time sufficient to remove at least a portion of the water from the reaction mixture, thereby forming a dehydrated reaction mixture (i) comprising the cyclic alkyl carbonate and the lignin, (ii) having a water content of 0.5 wt. % or less relative to the lignin, and (iii) being substantially free from an oxyalkylation catalyst;
adding an oxyalkylation catalyst to the dehydrated reaction mixture and performing an oxyalkylation reaction therein to react the cyclic alkyl carbonate with the lignin, thereby forming an oxyalkylated lignin polyol reaction product.

2. The method of claim 1, wherein the cyclic alkyl carbonate has an alkyl group containing from 2 to 20 carbon atoms.

3. The method of claim 1, wherein the cyclic alkyl carbonate has a structure according to Formula I: 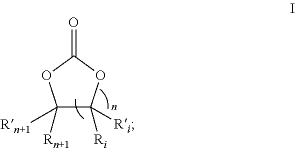
wherein:
n is 1 to 10;
i is each of 1 to n; and
Rᵢ, R′ᵢ, Rₙ₊₁, and R′ₙ₊₁ are independently selected from the group consisting of H and linear or branched, substituted or unsubstituted C₁-C₁₀ alkyl groups.

4. The method of claim 3, wherein:
n is 1;
R₁, R′₁, and R′₂ are H; and
R₂ is CH₃.

5. The method of claim 3, wherein:
n is 1; and
R₁, R′₁, R₂, and R′₂ are H.

6. The method of claim 3, wherein:
n is 2; and
R₁, R′₁, R₂, R′₂, R₃, and R′₃ are H.

7. The method of claim 1, wherein the cyclic alkyl carbonate comprises propylene carbonate.

8. The method of claim 1, wherein the lignin is derived from a biomass selected from the group consisting of hardwoods, softwoods, grasses, and combinations thereof.

9. The method of claim 1, wherein the lignin is isolated from an extraction process selected from the group consisting of Kraft extraction, soda extraction, organosolv extraction, enzymatic hydrolysis extraction, ionic liquid, extraction, sulfite extraction, and combinations thereof.

10. The method of claim 1, wherein the (unmodified) lignin, prior to incorporation into the reaction mixture, has at least one of the following properties:
a molecular weight in a range of 500 to 20000;
a polydispersity in a range of 1.2 to 8;
an aliphatic hydroxyl content in a range of 1 to 4 mmol/g;
a phenol hydroxyl content in a range of 2 to 5 mmol/g;
a carboxylic hydroxyl content less than 1 mmol/g; and
a total hydroxyl content in a range of 3 to 9 mmol/g.

11. The method of claim 1, the lignin, prior to incorporation into the reaction mixture, has the following properties:
a number-average molecular weight (Mn) in a range of 500 to 5000;
a polydispersity in a range of 1.2 to 8;
a phenol hydroxyl content in a range of 1 to 7 mmol/g;
a relative phenol hydroxyl content of at least 45% relative to hydroxyl groups of the unmodified lignin; and
a carboxylic hydroxyl content less than 1 mmol/g.

12. The method of claim 1, wherein the cyclic alkyl carbonate is present in the reaction mixture in an amount in a range of 2 eq to 10 eq relative to the lignin hydroxyl content.

13. The method of claim 1, wherein the reaction mixture contains less than 0.01 wt. % of an oxyalkylation catalyst based on the reaction mixture.

14. The method of claim 1, wherein:
the lignin initially in the reaction mixture comprises water in an amount in a range of 5 wt. % to 70 wt. % relative to the lignin; and
the dehydrated reaction mixture has a water content of 0.2 wt. % or less relative to the lignin.

15. The method of claim 1, comprising heating the reaction mixture to remove the water at a temperature in a range of 100° C. to 230° C.

16. The method of claim 1, comprising adding the oxyalkylation catalyst to the dehydrated reaction mixture in an amount in a range of 0.01 eq to 0.2 eq relative to the lignin hydroxyl content.

17. The method of claim 1, wherein the oxyalkylated lignin polyol reaction product has an aliphatic hydroxy content in a range of 0.2 mmol/g to 6 mmol/g.

18. The method of claim 1, comprising performing the oxyalkylation reaction at a temperature in a range of 100° C. to 200° C.

19. The method of claim 1, comprising performing the oxyalkylation reaction in a sealed reaction vessel.

20. The method of claim 19, further comprising:
venting carbon dioxide produced during the oxyalkylation reaction from the sealed reaction vessel.

21. The method of claim 1, further comprising:
adding additional cyclic alkyl carbonate and additional oxyalkylation catalyst to the dehydrated reaction mixture while performing the oxyalkylation reaction.

22. The method of claim 1, further comprising:
adding an isocyanate to the oxyalkylated lignin polyol reaction product and reacting the isocyanate and the oxyalkylated lignin polyol reaction product to form a polyurethane polymer.

23. The method of claim 1, further comprising:
adding an organic acid to the oxyalkylated lignin polyol reaction product and reacting the organic acid and the oxyalkylated lignin polyol reaction product to form a polyester polymer.

24. An oxyalkylated lignin polyol reaction product formed according to the method of claim 1.

25. A polyurethane polymer comprising:
a reaction product between the oxyalkylated lignin polyol reaction product of claim 24 and an isocyanate.

26. A polyurethane polymer formed according to the method of claim 22.

27. A polyester polymer comprising:
a reaction product between the oxyalkylated lignin polyol reaction product of claim 24 and an organic acid.

28. A polyester polymer formed according to the method of claim 23.
